(19) United States
(12) Patent Application Publication
(10) Pub. No.: US 2005/0041667 A1
(43) Pub. Date: Feb. 24, 2005

(54) Calendar channel

(75) Inventors: Roger Colin Miller, Sammamish, WA (US); Burdette Holtgrewe, Bellevue, WA (US); Albert W. Tan, Redmond, WA (US); Dane M. Howard, Sammamish, WA (US); Paul J. VanderSpek, Seattle, WA (US); James W. Cooley, Redmond, WA (US); Keith Curtis, Seattle, WA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/949,235

(22) Filed: Sep. 24, 2004

Related U.S. Application Data
(63) Continuation-in-part of application No. 10/611,373, filed on Jun. 30, 2003.

(51) Int. Cl. H04L 12/56; H04J 3/24

(52) U.S. Cl. 370/395.4; 370/399; 370/474

(57) ABSTRACT

The present invention provides a calendar channel that provides a user of a mobile electronic device simple access to calendar information. The user may customize the calendar content they receive on their devices. While using the calendar channel, users automatically receive broadcast calendar information, including event and appointment information. Example modes include: appointments view, event view, and month view. The appointment view mode is organized to display appointment information on the electronic device. The event view mode is arranged to display event information that is organized according to a day list format. The month view mode displays the days of the month. The calendar channel is synchronized and customized by the user from a single user interface.

This application is a continuation-in-part of application Ser. No. 10/611,373, filed Jun. 30, 2003, which is incorporated herein by reference in its entirety.

### BACKGROUND OF THE INVENTION

Mobile electronic devices, such as cell phones, wireless PDAs, wireless laptops and other mobile communication devices are making impressive inroads with consumers. Many of the mobile electronic devices are able to perform a variety of tasks and include a user interface to help the user access the features associated with the device. For example, some mobile devices include a display unit that displays graphical data to support email, instant messaging, web browsing, and other non-voice features. Using their mobile devices, users access the Internet, send and receive email, participate in instant messaging, and perform other operations. Accessing the desired information, however, may be cumbersome for the user. When accessing the Internet, for instance, users have to log onto the network and then type in information to access the information they desire. Additionally, using the user interface to access the information may be difficult.

### SUMMARY OF THE INVENTION

The present invention is directed at providing a calendar channel that includes calendar content delivered to a user on a mobile device.

According to one aspect of the invention, calendar content associated with the calendar channel is automatically delivered and stored on a mobile electronic device for access by a user. Using the device, users can quickly access their calendar information they are interested in without having to type in information to specifically download the calendar content to the device. The calendar channel is directed at providing a quicker and less cumbersome way of accessing a user's calendar information as compared to having to access a user's calendar program on their desktop.

According to another aspect of the invention, the calendar channel includes several different modes for categorically displaying different types of calendar information. Some example modes include: an appointments mode; an events mode, and a month view mode.

According to yet another aspect of the invention, the user may customize the calendar information they receive on their device. For example, using a web interface, the user may select which events they wish to receive on their device.

A more complete appreciation of the present invention and its improvements can be obtained by reference to the accompanying drawings, which are briefly summarized below, to the following detailed description of illustrative embodiments of the invention, and to the appended claims.

### BRIEF DESCRIPTION OF THE DRAWINGS FIG. 1 illustrates an operating environment;

FIG. 2 shows an electronic device;

FIG. 3 illustrates an exemplary smart object watch devices that include a user interface for navigating through channels and content;

FIG. 4 illustrates a system for delivering and configuring channel information to an electronic device;

FIGS. 5A-5D illustrate process flows for passive and active navigation functions of a electronic device;

FIG. 6 shows exemplary status indicator headers;

FIG. 7 illustrates exemplary modes for a calendar channel;

FIG. 8 illustrates an appointments mode;

FIG. 9 illustrates an events mode;

FIG. 10 illustrates a month view mode;

FIG. 11 illustrate a web user interface for inputting user preferences for a calendar channel; and

FIG. 12 illustrates encoding calendar data, in accordance with aspects of the present invention.

### DETAILED DESCRIPTION OF THE PREFERRED EMBODIMENT

The apparatus, system, and method of the present invention are related to navigating through calendar content on a device that includes stored calendar related information. The calendar content may be selected and viewed on a display of the device by means of passive interaction (e.g., hands free operation) or active interaction (e.g., selecting buttons).

In the described embodiments, the electronic devices may be mobile devices, such as smart watches, that are specially configured to receive communication signals. The electronic devices may be configured to receive broadcast transmissions from one or more broadcast towers and are capable of receiving and processing messages from the broadcast transmissions.

The electronic devices store the received information such that the information is indexed according to designated channels. Each channel includes content that is organized according to a set of criteria. For example, calendar content is presented in one channel; wherein sports content is presented in another channel. Some channels may include content from one or more of the other channels. For example, a messages channel may include calendar related alerts. After information is received and processed by the client device, a user may passively or actively review the information that is stored in the electronic device.

One of the particular channels corresponds to a calendar channel. The calendar channel on each device may be customized based on user preferences such that the user experience is enhanced. An example calendar channel may be configured to display event information a user in interested in, as well as display a user's calendar information retrieved from their calendar program.

Although described here in the context of a watch-based system, other mobile or non-mobile devices, such as portable and desktop computers, personal digital assistants (PDAs), cellular telephones, and the like, may be used. The use of a watch is for illustrative purposes only to simplify the following discussion, and may be used interchangeably with “mobile device” and/or “electronic device”.

The term “content” can be any information that may be stored in an electronic device. By way of example, and not limitation, content may comprise graphical information, textual information, and any combination of graphical and textual information. Content may be displayable information or auditory information. Auditory information may comprise a single sound or a stream of sounds.

Exemplary Smart Object Device

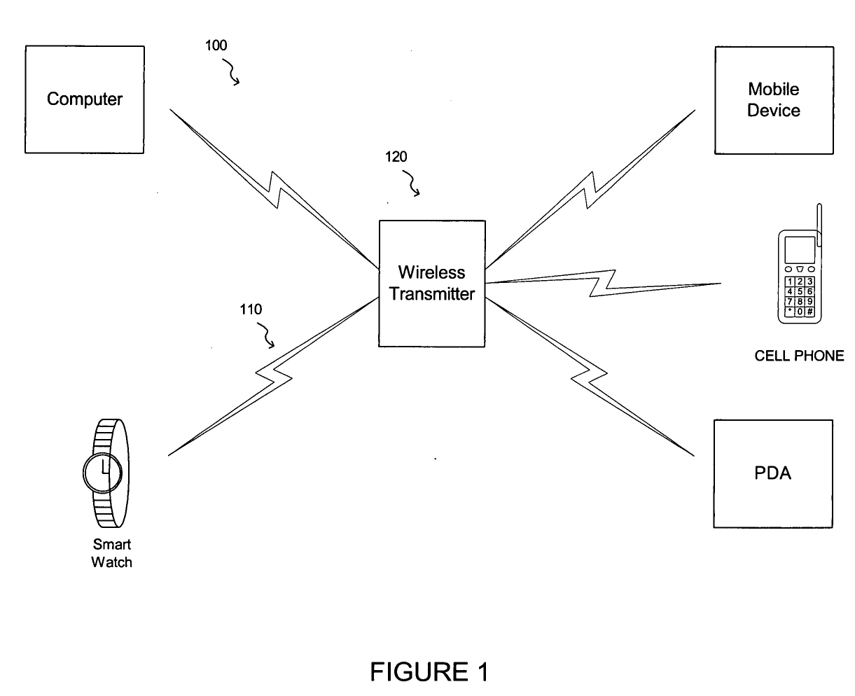

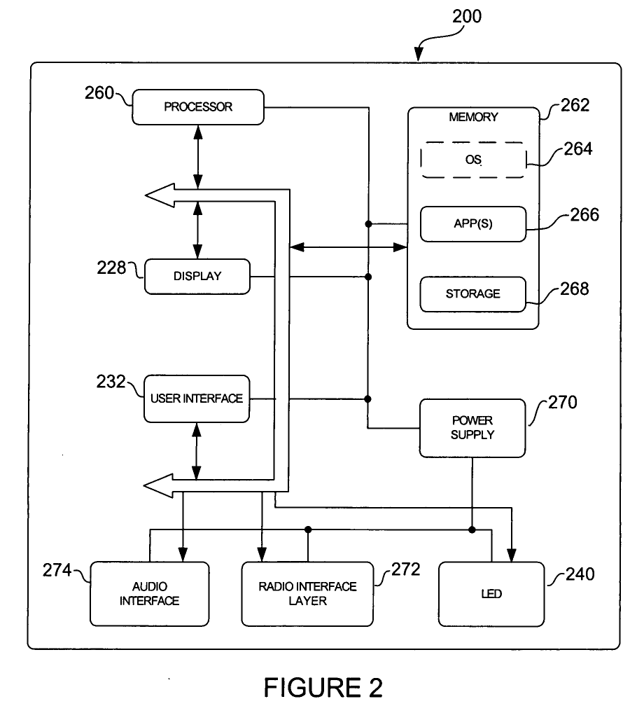

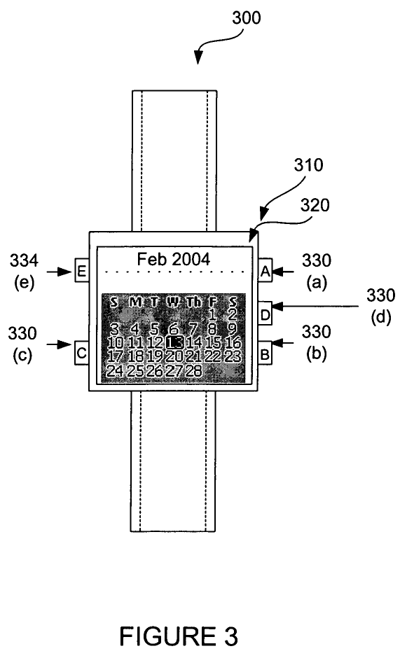

FIG. 3 illustrates an exemplary smart device that includes a user interface that is configured to interact with content from channels, in accordance with aspects of the invention. Watch device 300 includes bezel 310 which has an electronic system. The electronic system performs the functions in a manner that is consistent with the hardware that is described with respect to FIG. 2. Bezel 310 includes display 320, such as a liquid crystal display, a multiple bit display, or a full color display. In one embodiment, watch hands are electronically generated on display 320 when the user is in a time mode. In an alternative embodiment, the bezel includes analog-type watch hands that do not detrimentally interfere with display 320. As illustrated, display 320 shows a view in a calendar channel for a month view of February 2004.

Watch device 300 includes a series of selectors, such as buttons A-D (330a-d), which are arranged to operate as part of a user interface (UI). Each selector may have a default function and/or a context determined function. The currently selected channel determines the context for each selector. Alternatively, the currently active display may determine the context for each selector. For example, a display screen (e.g., a help screen) may be superimposed on the main display such that the display screen becomes the active context. Watch device 300 is context sensitive in that the function that is associated with each selector may change based on the selected channel or display screen.

Button “A” has a default function of page up or previous page in the currently selected channel. Button “A” may also have an alternate function based on the currently selected channel or display. Button “B” has a default function of page down or next page in the currently selected channel. Button “B” may also have an alternate function based on the currently selected channel or display. In one example, button “B” is activated for a predetermined time interval (e.g., two seconds) to select a “speed list browse” function.

Button “C” has a default function of next channel. Button “C” may also have an alternate function based on the currently selected channel or display. In one example, button “C” is activated for a predetermined time interval (e.g., two seconds) to select the main channel or “primary” channel. The main channel in an example watch device is the time channel that provides the user with time related information. However, devices may be configured to have some other display screen that is recognized by the device as a “primary” channel or “home” location.

Button “D” has a default (or “primary”) function of “enter.” The “enter” function is context sensitive and used to select the “enter” function within a selected channel (e.g., enter My Cities mode), or to select an item from a selection list (e.g., select a city). Button “D” may also have an alternate function based on the currently selected channel or display. For example, the “D” selector is activated for a predetermined time interval (e.g., two seconds) to activate a delete function. In another example, the “D” button may be selected for a predetermined time to activate a help screen or an additional set mode. In this example, the help screen remains active while button “D” is activated, and the help screen is deactivated (e.g., removed from the display) when the “D” button is released. According to another embodiment, the “D” button may also perform another function; such as showing the date or time; initiating a custom action/animation; and the like.

The selectors are arranged such that the electronic device accomplishes navigating and selecting content on each channel in a simple manner. An optional fifth selector (e.g., button “E”) may be arranged to provide other functions such as backlighting or another desired function. Other selectors may also be included.

Example Calendar Channel Views

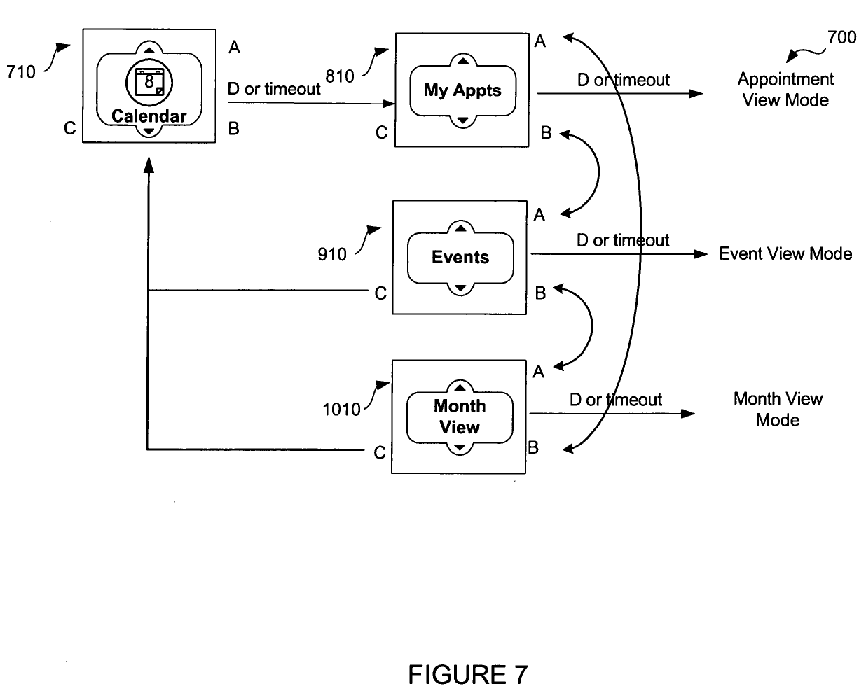

FIGS. 7-10 are diagrams illustrating example views for various modes for a calendar channel that is arranged in accordance with the present invention. The calendar channel may be configured for multiple operating modes. Example operating modes include an appointment mode, an event view mode, and a month view mode. Each operating mode may have a separate mode splash-screen, as illustrated in FIG. 7.

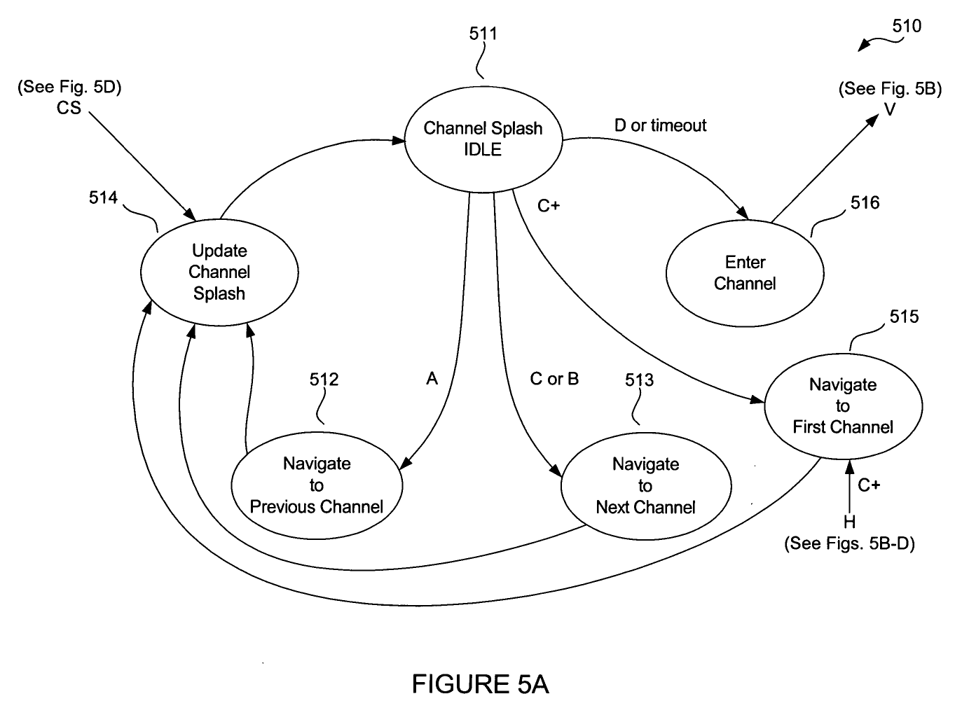

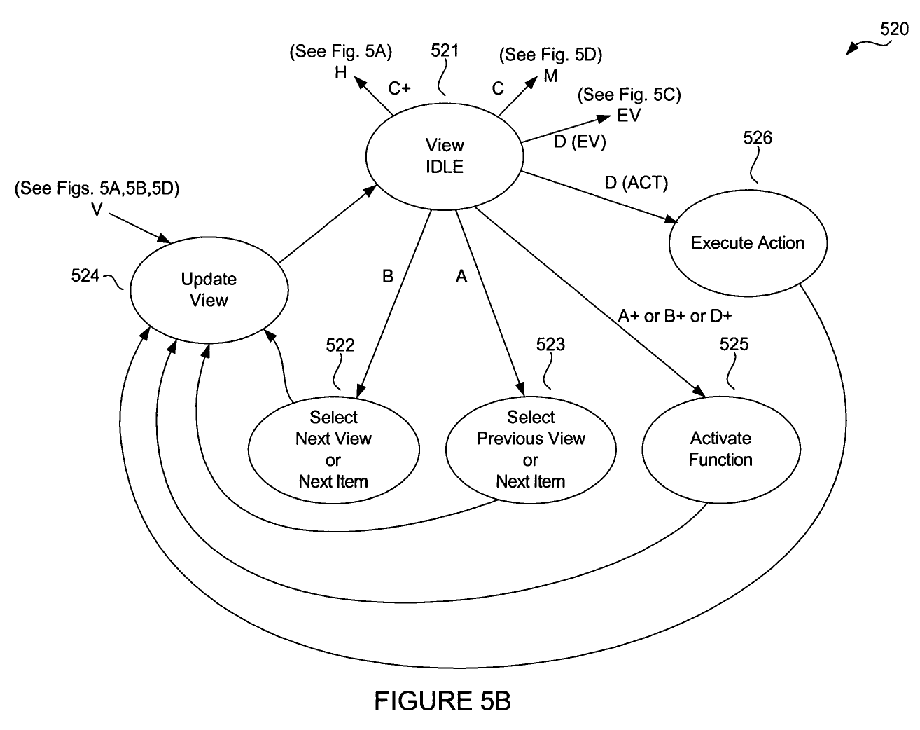

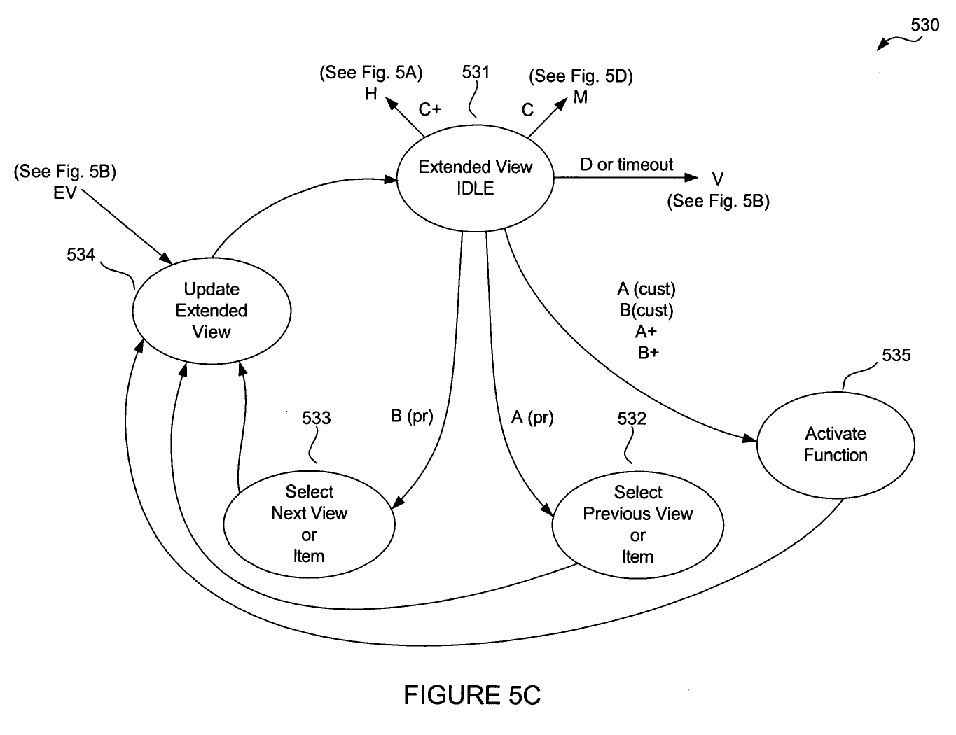

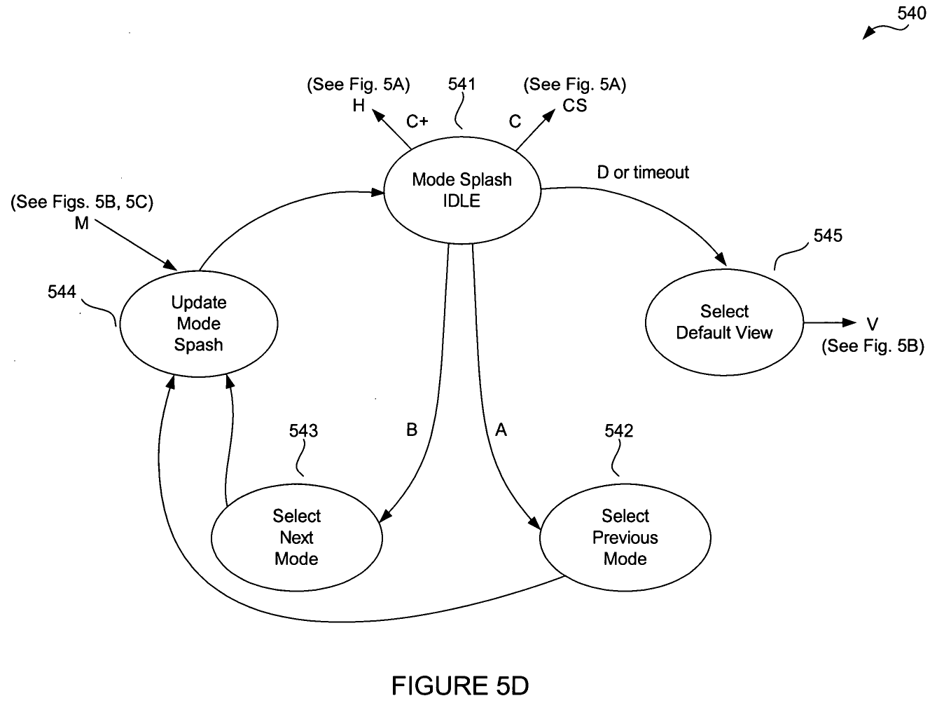

A mode splash-screen (e.g., see FIG. 7) is displayed when the mode is changed. In one example, the mode may be changed by selective activation of the next and previous selectors (e.g., the “a” and “b” buttons) when any mode splash screen is active (see FIG. 5D). The mode splash screen may be dismissed via a timeout condition or by activation of the “d” selector (or enter function). Each mode has a series of associated views.

A channel splash-screen (810) for the calendar channel is displayed when the calendar channel is initially selected. The calendar channel splash screen may include a date indicator as illustrated in FIG. 7, where the date on the splash screen changes for each day of the month. After the calendar channel is selected, the appointment mode is activated by the expiration of a timeout period (e.g., ten seconds) without user interaction, or by activation of the “d” or “enter” selector. The channel splash can be selected from any one of the mode splash screens by activation of the “c” selector (See FIG. 5D and FIG. 7).

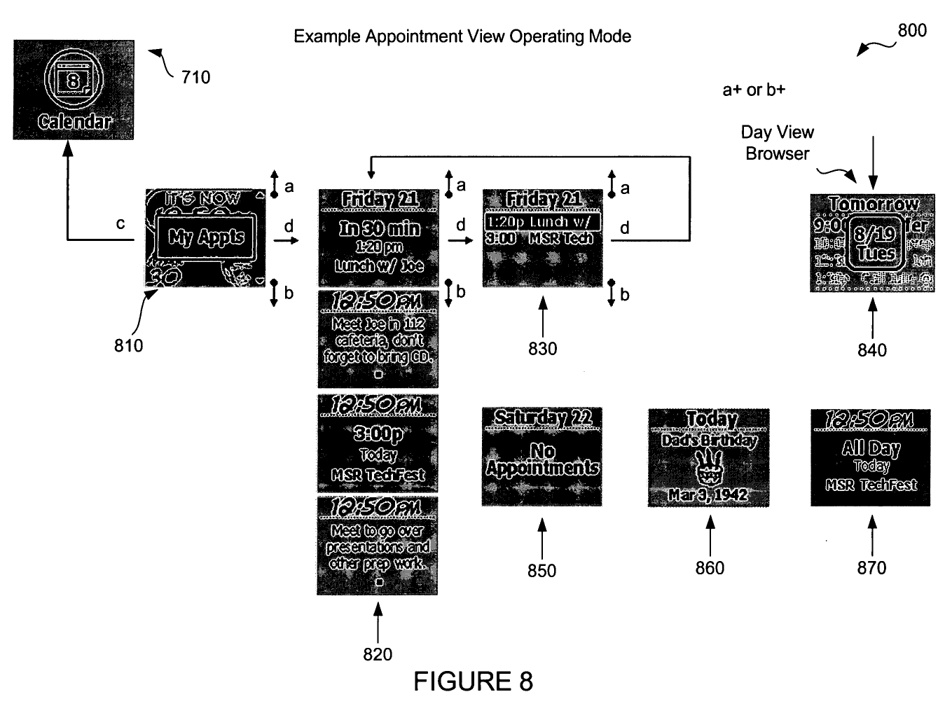

The channel splash-screen is dismissed after a mode is selected, such as when the appointment mode is activated. After the channel splash-screen is dismissed, the first upcoming appointment (e.g., see 820 from FIG. 8) is displayed on the electronic device. The appointment mode of the channel may include many display views (820) that each correspond to appointments on the schedule. Example appointments that are illustrated in FIG. 8 include “Lunch w/Joe”, and “MSR Techfest”.

Each appointment view may be partitioned into a header section, and a main body section. The header section may display the current time or date. The header section may be formatted such that: expired appointments are indicated by text such as “Past”, immediate upcoming appointments are indicated by text such as “Next”, today's appointments are indicated by text such as “Today”, and subsequent days appointments are indicated by the day of the week followed by a numerical date (e.g., “Mon 10”, “Tue 11”, etc.).

The header section may also have two views as illustrated in FIG. 8. A first header view indicates the current date such as “Friday 21”, while the second header view indicates the current time such as “12:50PM”. After a first delay time, the header section of the display screen may change from the first header view to the second header view. After a second delay time, the header section of the display screen may change back to the first header view. The toggling of the display section may be referred to as a passive interaction that is activated by “parking” the electronic device in the appointment mode of the calendar channel. The passive interaction is deactivated by activation of one or more selectors on the electronic device.

The main body section of each appointment view may indicate the amount of time remaining until the scheduled appointment (e.g. “in 30 min”, “3:00P”, etc.), the time of the scheduled appointment (e.g. “1:20 pm”, “3:00P”, “All Day”), and an abbreviated form of the appointment detail. The main body section may also include a combination of text and graphic elements that are centered on the display both horizontally and vertically beneath the header section (e.g., see 860). “All day” appointments are illustrated by screens 860 and 870. Similar to the header section, the main body section of the display area may be periodically updated when passive interaction is activated by parking the device on the appointment mode of the calendar channel. While the current appointment is parked on the display, the electronic device continues to monitor the time relative to the appointment so that the display can be updated accordingly. For example, the time until the next appointment will count down while the channel is parked on the appointment view.

Appointments are automatically selected when the day and time of the appointment become the most imminent non-expired appointment in the schedule. Expired appointments may not be displayed on the device unless actively browsed (e.g., activation of the “previous” function by depressing the “a” selector) since they are no longer imminent appointments. The electronic device will display the summary for the currently selected appointment while the appointment mode is active. The selected appointment may be manually advanced by pausing the appointment mode with the activation of the next and previous selectors (e.g., “a” and “b” selectors). An empty or “no appointments” screen such as display screen 850 can be displayed when there are no imminent appointments remaining.

The electronic device may be arranged to apply a logic rule set to dynamically change the content that is associated with the header and main body sections of the display. The rule set changes the behavior of the device as time progresses. An example rule set requires that appointments that are more than 30 minutes in the future are indicated as “Today” instead of “In XXX Minutes”. For example (See FIG. 8), a single appointment (e.g., “MSR Techfest”) is scheduled for 3PM on Friday 21^{st}. Early in the day (e.g., 8AM), the appointment is in the distant future and the time of appointment is indicated as “3PM” and “Today”. The display changes to indicate “In 30 min.” at 2:30PM of that day, and subsequently counts down to the appointment. Other rule sets may also be applied such as appointments or events that are beyond 12AM are indicated as “Tomorrow”, appointments or events that are beyond 48 hours are indicated as “in XXX days”

The appointment view mode includes a special type of selection list that includes a header section and an abbreviated list of all of the events and appointments for each day. The list is organized on a day-by-day basis. An example list for a days schedule is illustrated by view 830 in FIG. 8. The selection list for the days schedule may be organized as a header section, and a main body section. The header section may display the currently selected day such as, for example, “today”, “yesterday”, “tomorrow”, and a day followed by a numerical date (e.g., “Thu 17”). The main body section may include an area for time of the appointment or event, and an area for a brief description. The time of the appointment or event may be left justified in a first column of the display, while the brief description may be left justified in a second column of the display. All day events do not include a time and thus the brief description of the all day event may be centered on the display area for the item.

Activation of the next and previous selectors (e.g., the “a” and “b” selectors) allows the user to select the list items from the days schedule. The currently selected item in the schedule is indicated by a graphical indicator such as a reverse blit effect on the text associated with the selected item. The selected item activation of the “enter” (e.g., the “d” selector) will enter the detailed view for the selected item. After the detailed view is active, activation of the “next” and “previous” selectors will scroll through the various items in the days schedule in detailed view. Activation of the “enter” function from the detail view cycles the display to the day view mode splash-screen, which permits selection of another mode if desired.

A day browser may be available in the appointment view operating mode of the calendar channel. The day browser is activated by accessing an alternate selector functions such as “a+” and/or “b+”. The alternate selector function may be accessed by sustained activation of a selector button for a predetermined time interval (e.g., two seconds). The day browser function may be arranged as an overlay that includes the current date (e.g., “8/19 Tues”) as illustrated by display screen 840 in FIG. 8.

The detailed views (e.g., display screens 820) that are associated with a current appointment can be displayed by activating the next function (e.g., the “b” selector). The detailed views may span a single display screen or multiple display screens. Detailed views can be scrolled through using the “previous” and “next” selectors. When the current detail view is the last view for a particular appointment, activation of the “next” selector will go to detail view of the next imminent appointment. Activation of the “enter” function from the detail view cycles the display to the list selection screen, which permits selection of another appointment if desired.

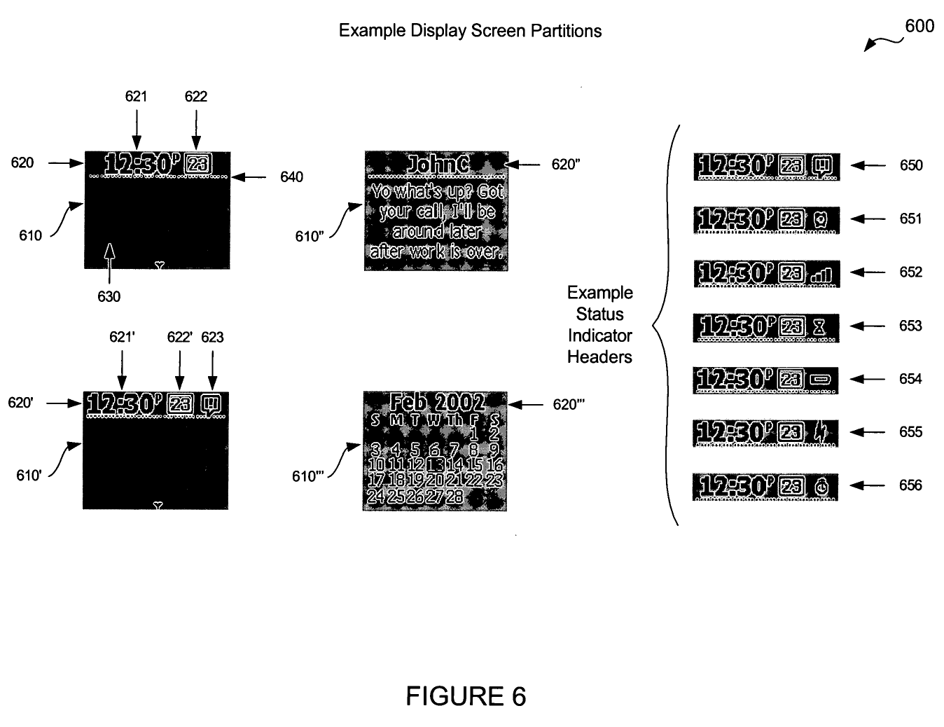

Each appointment may have a status that is indicated by an alternating view when the appointment operating mode is active. As shown in FIG. 6 and FIG. 8, each appointment has a header section and a main body section.

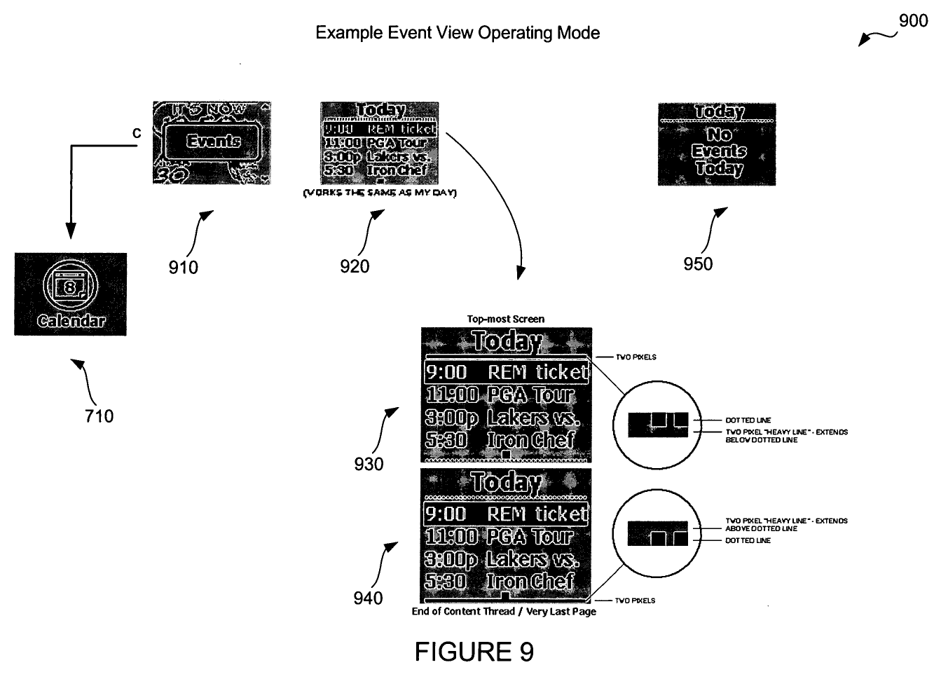

The event view mode is illustrated in FIG. 9, and may include a number of views (900) that correspond to a list formatted overview of the user's event schedule for the current day. This mode functions substantially the same as the appointment view operating mode that was described previously with respect to FIG. 8.

According to one embodiment, the user may select to receive event information from a predetermined number of events. For example, the events could include MLB Baseball Schedules including Individual home and away listings for each team including the opponent, date, start timer (based on the time zone of the watch), the location and the TV network that is covering the game if appropriate. NFL Football Schedules including individual home and away listings for each team including the opponent, date, start timer (based on the time zone of the watch), the location and the TV network that is covering the game if appropriate. MBA Basketball Schedules including individual home and away listings for each team including the opponent, date, start timer (based on the time zone of the watch), the location and the TV network that is covering the game if appropriate. NHL Hockey Schedules including individual home and away listings for each team including the opponent, date, start timer (based on the time zone of the watch), the location and the TV network that is covering the game if appropriate. NASCAR/CART Race Schedules including race listings by name, location date, start timer (based on the time zone of the watch), the location and the TV network that is covering the race if appropriate. Professional Tennis Schedules including event listings by name, date, the location and the TV network that is covering the race if appropriate. Concert and Festival Schedules including event listings by name, date, and the venue/location.

Appointment lists such as from the appointment view and event view operating modes may be configured with appointment bookends as illustrated by display screens 930 and 940 in FIG. 9. The header section of display screen 930 is separated from the main body section by a horizontal line that indicates the top of the list, while the bottom of display screen 930 includes a dotted horizontal line to indicate that the list continues on the next display screen. Similarly, the header section of display screen 940 is separated from the main body section by a dotted horizontal line that indicates the top of the list is on the previous screen, while the bottom of display screen 940 includes a horizontal line to indicate the end of the list for the day's events and/or appointments. An empty event or “no events” screen such as display screen 950 can be displayed when there are no events scheduled for the day.

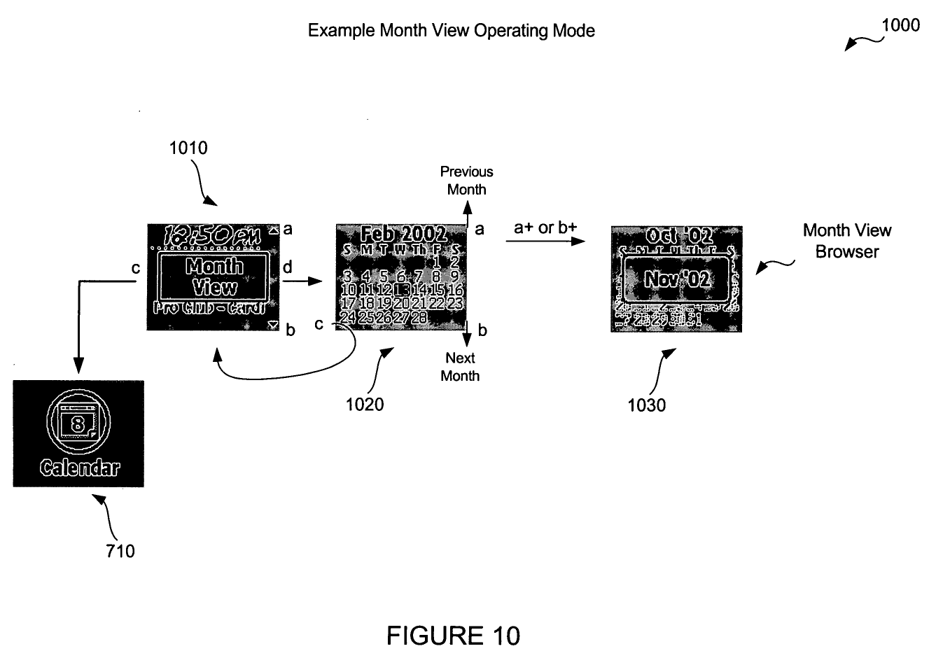

The month view mode is illustrated in FIG. 10, and may include a number of views that correspond to each month of the user's schedule. This mode allows a user to view a monthly calendar. The monthly calendar includes a graphical indicator of the current day such as, for example, an inverse blit effect on the current day (see e.g., 1020). The month view includes a header section and a calendar section. The header section of the display includes a date indicator such as the month and year of the currently selected calendar (e.g., “Feb 2002”). The calendar section is laid out similar to a desktop calendar as shown in FIG. 10.

Activation of the next and previous selectors (e.g., the “a” and “b” selectors) in the month view operating mode will cycle the display through previous and subsequent months on the calendar. A month browser (see e.g., 1030) is available in the month view operating mode of the calendar channel. The month browser is activated by accessing an alternate selector functions such as “a+” and/or “b+”. The alternate selector function may be accessed by sustained activation of a selector button for a predetermined time interval (e.g., two seconds). The month browser function may be arranged as an overlay that includes the currently selected month (e.g., “Nov ‘02”) as illustrated by display screen 1030 in FIG. 10. Activation of the “c” selector or “mode select” function from the detail view cycles the display to the month view mode splash-screen, which permits selection of another mode if desired.

User Interface for Configuring the Calendar Channel

The calendar channel is arranged to provide simple access to time based schedules and information on the electronic device. Appointments and reminder type functions are customized based on user preferences. The user preferences and schedules may be provided as information that is retrieved from broadcast transmissions such as described herein. Schedules can be selected via a computer type interface such as through an internet based application, a computer based application, or any other reasonable method of accessing and altering scheduling information. Schedules may be synchronized such that a user only is required to update the scheduling information in a single location.

In one example, a subscriber to the calendar feature can access an internet based application such as the MSN® calendar service to select or change various features for the calendar channel. In another example, a subscriber uses an calendar application program such as Microsoft® Outlook® to revise and set schedules. Each day at a predetermined time (e.g., midnight), the appointments from the previous day can be deleted, and appointments for the next days are updated. Throughout the day, various facilities can be provided such that the revisions to the calendar channel content are synchronized through the broadcast transmissions that are received by the electronic device.

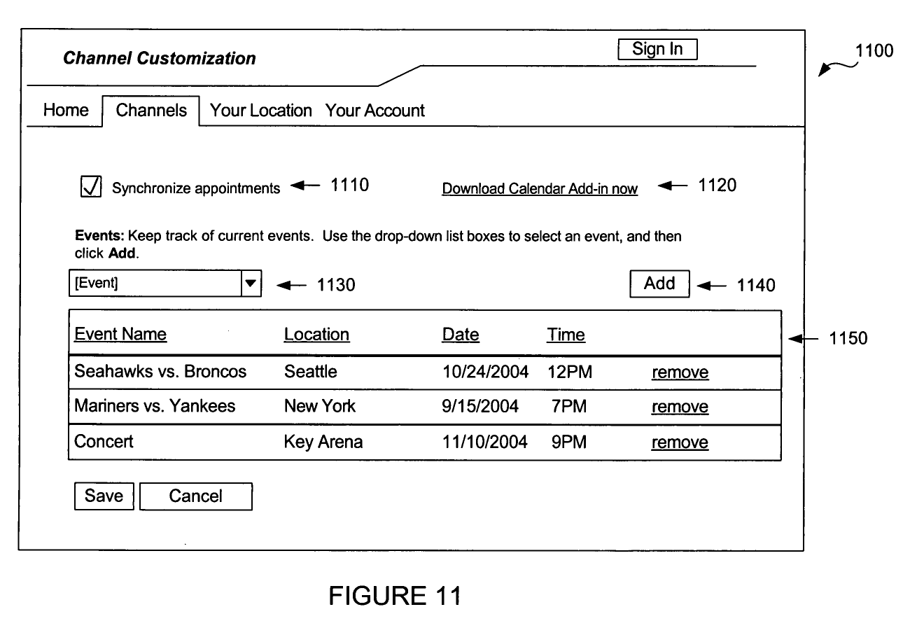

FIG. 11 illustrates a web user interface for inputting user preferences for a calendar channel, in accordance with aspects of the invention. The web interface illustrated is only an example of one interface that may be used to input user preferences for the calendar channel.

Various calendar options can be selected via a computer type interface such as through an internet based application, a computer based application, or any other reasonable method of accessing and altering configuration information. In one embodiment, a subscriber to the calendar channel can accesses web page 1200 to select or change various features associated with the calendar channel. In another embodiment, calendar information already being tracked on a user's calendar application may be retrieved and then used to populate the calendar preferences for the calendar channel.

Synchronize appointments (1110) may be selected by checking the appropriate checkbox next to the desired option. In the example illustrated, the user has selected to synchronize and receive their appointments from maintained on their calendaring program.

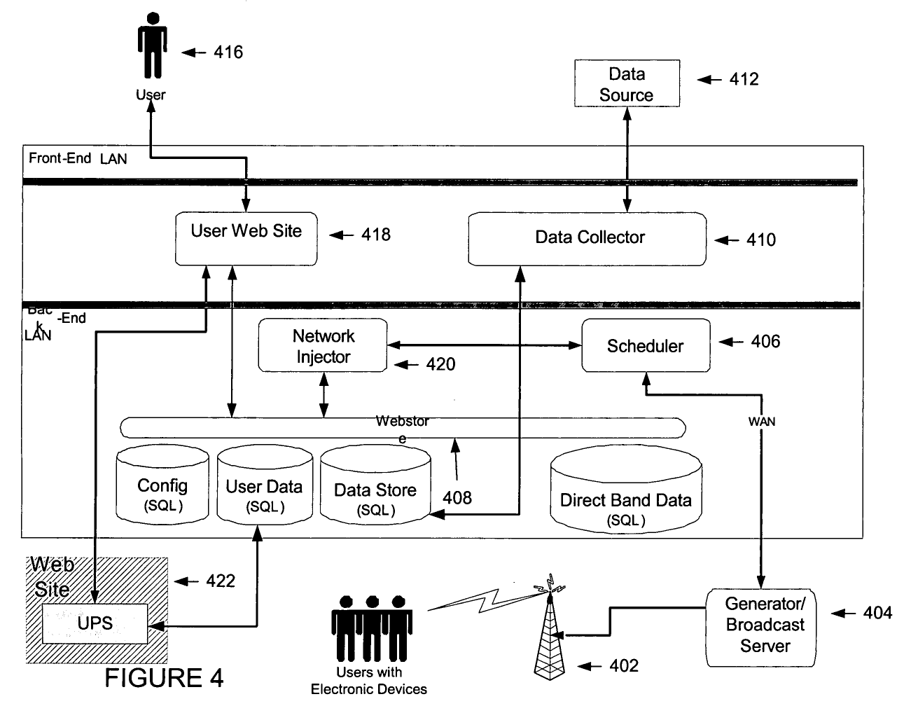

Link 1120 may be selected to download a calendar add-in program that interfaces with the user's calendar program. The add-in is able to read and send calendar information such that the broadcast server can broadcast the information to the user's device (See description below in FIG. 4)

According to one embodiment, the user may select events they are interested in receiving.

Dropdown list 1130 is populated with events based on the user's home location. The user can add/change the events by using dropdown lists 1130 and selecting the “Add” button (1140). After the event is added, the event is added to list 1150.

When a user reaches a predetermined limit of events the “Add” button is grayed out and text appears explaining that the number of events selected is limited. When the user clicks on a “remove” link next to the event, list 1150 refreshes and is displayed without that event. Once the user selects the “Save” button, the device is updated accordingly.

Data Feed and Encoding

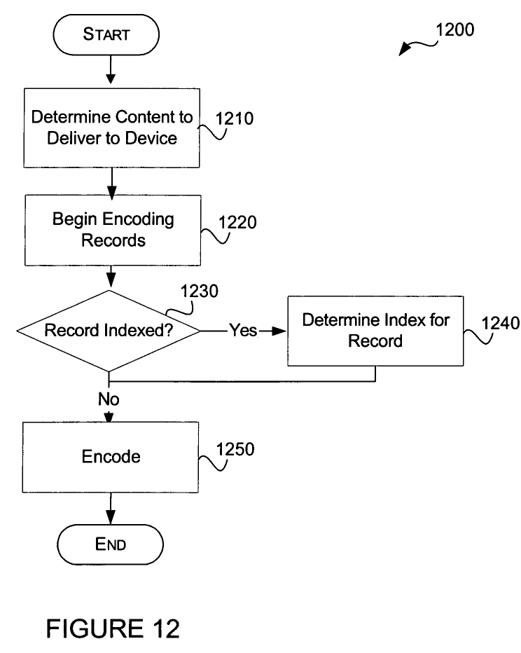

FIG. 12 illustrates encoding calendar data, in accordance with aspects of the invention. After a start block, the process moves to block 1210 where a determination is made as to what content is going to be delivered to the device.

Moving to block 1220, the encoding process begins (See below for exemplary encoding).

Transitioning to decision block 1230, a determination is made as to whether the data record is part of an index. Generally, any information that is static and that is broadcast multiple times may be encoded as an index. For example, city names, team names, location venues, and the like may be encoded as part of an index, such that each name does not need to be delivered to the device each time the name is referenced. Indexing the content reduces the amount of data that needs to be broadcast. For example, sending each city name in each broadcast would consume a large amount of bandwidth. The content may be indexed by assigning an ID to each name. According to one embodiment, the index starts at one and ends at the last city, team name, venue, and the like. The names and their associated IDs may be delivered to the device in a configuration message such that when the device receives a calendar channel broadcast the device may associate the ID with the name.

When the record is encoded as an index, the process moves to block 1240, where the index value is determined for the record.

When the record is not encoded as an index, the process moves to block 1250, where the record is encoded. According to one embodiment, the value of the record is stored within a predetermined number of bits.

Operating Environment

FIG. 1 illustrates an example operating environment for the present invention. As illustrated, operating environment 100 includes wireless transmitter 120 that is responsible for delivering content to wireless devices. According to one embodiment, the wireless transmitter may include a cellular tower that is used to communicate with mobile devices, such as cell phones, notebooks, pocket PCs, long-distance communication links, and the like. According to another embodiment, the wireless transmitter may include an FM transceiver that broadcasts signals over communication channel 110 to the various electronic devices. The FM broadcast may be any number of types including but not limited to: a standard FM transmission, a sub-carrier FM transmission, or any other type of FM transmission as may be desired. Example electronic devices that have an FM receiver or transceiver may include a desktop computer, a watch, a portable computer, a wireless cellular telephone (cell phone), and a personal data assistant (PDA). The electronic devices are arranged to receive information from the wireless broadcast.

Some example electronic devices that may include an electronic system arranged to operate according to the interaction model are illustrated in FIG. 1. Each of the electronic systems receives messages/information over the communication channel.

According to one embodiment, each broadcast transmission corresponds to the transmission of one or more frames. Each frame may include multiple messages, where some messages are public broadcast (aka “global” or “shared” messages), while other messages are client specific messages (aka “personal” or “private” messages). Every client that is located within the designated service region may receive shared messages, while a single client may decode a private message.

Electronic devices (e.g., a wireless watch device) receive message packets according to shared and private messages that are directed to the client device. Message packets are organized in groups according to logical slot (or channel) entry numbers. For example, a particular electronic device is configured to receive a selected group of channels from the available channels. The message packets associated with each of those channels is received, processed, and stored in the client device. The stored message packets can be reviewed using a user interface that employs an interaction model, in accordance with the present invention.

Example channels include: a calendar channel, a weather channel, a sports channel, a time channel, a messages channel, a stocks channel, a news channel, and a movies channel. Messages associated with each channel include message content that is based on the particulars of the channel.

FIG. 2 is a schematic diagram illustrating functional components of an illustrative electronic device that may be used to interact with channel content, in accordance with aspects of the invention. Electronic device 200 includes processor 260, memory 262, display 228, and user interface 232. Memory 262 generally includes both volatile memory (e.g., RAM) and non-volatile memory (e.g., ROM, Flash Memory, or the like). Electronic device 200 may include an operating system 264, such as the Windows CE operating system from Microsoft Corporation or another operating system, which is resident in memory 262 and executes on processor 260. User interface 232 may be a series of push buttons, a scroll wheel, a numeric dialing pad (such as on a typical telephone), or another type of user interface means. Display 228 may be a liquid crystal display, or any other type of display commonly used in electronic devices. In one example, display 228 may be touch-sensitive that would act as an input device.

One or more application programs 266 are loaded into memory 262 and run on the device. Examples of application programs include calendar programs, weather programs, sports programs, movie programs, time programs, and so forth.

Electronic device 200 also includes non-volatile storage 268 that is located within memory 262. Non-volatile storage 268 may be used to store persistent information which should not be lost if electronic device 200 is powered down. Applications 266 may use and store information in storage 268, such as weather content used by a weather application, appointment information used by a calendar program, and the like.

Electronic device 200 includes power supply 270, which may be implemented as one or more batteries. Power supply 270 might further include an external power source, such as an AC adapter or a powered docking cradle that supplements or recharges the batteries.

Electronic device 200 is also shown with two types of external notification mechanisms: LED 240 and audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 is used to provide audible signals to and receive audible signals from the user. For example, audio interface 274 may be coupled to a speaker for providing audible output and to a microphone for receiving audible input, such as to facilitate a telephone conversation, or as a user interface using voice recognition. In another example, a vibration device (not shown) can be used to give feedback to the user such as for alerting the user of a newly arrived content. Electronic device 200 can control each alert mechanism separately (e.g., audio, vibration, as well as visual cues).

Electronic device 200 also includes a communication connection, such as radio interface layer 272, which performs the function of receiving and/or transmitting radio frequency communications. Radio interface layer 272 facilitates wireless connectivity for electronic device 200. Transmissions to and from radio interface layer 272 are conducted under control of the operating system 264. In other words, communications received by radio interface layer 272 may be disseminated to application programs 266.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are included within the scope of computer readable media.

In one example of the present invention, electronic device 200 is a mobile electronic device such as a watch device that includes a wireless interface. An exemplary watch device is shown in FIG. 3.

Broadcast Channels

FIG. 4 illustrates a system for delivering and configuring channel information to an electronic device, in accordance with aspects of the invention.

A user, such as user 416, may customize their channels through user web site 418. Using website 418 the user may set options and select information associated with channels to which they have subscribed. For example, the user may select the events they desire to receive information on using website 418. The selected options are stored in a data store, such as webstore 408. Channel information and various options may also be automatically retrieved from a web site to which the user participates in. For example, web site 422 may be the user's home page in which the user has already selected various options customizing their page. These options may be used to populate the options associated with various channels. For example, a user's calendar information may be used in a calendar channel, a user's selected cities may be used in a weather channel, the user's selected theaters may be used in a movies channel, a user's selected stocks they desire to track may be used in a stock channel, and the like.

Data Collector 410 is configured to collect data from one or more data sources, such as data source 412, relating to a channel. For example data collector 410 may retrieve a user's work appointments from one data source, a user's personal appointments from another source, and event content from yet another data source. According to one embodiment, the data feed for the calendar channel is obtained from the user's calendaring program on their desktop computer

The data obtained varies depending on the calendar content that is delivered to the device. After the data is obtained, the data is encoded and then sent to the device. The data collected by data collector 410 may be stored in a data store, such as webstore 408, for later broadcast.

Broadcast transmitter tower 402 is arranged to provide a communication signal that is configured for reception by users with electronic devices that are located within a service region. Broadcast tower 402 transmits in response to generator/broadcast server 404. Generator 404 may communicate with scheduler 406 via a network communication link. Scheduler 406 is configured to schedule broadcast transmissions relating to channel information.

Selected services are entered in a database, such as webstore 408 for broadcast transmission at a later time. At the designated time (or time interval) scheduler 406 communicates with broadcast server 404 to begin a transmission sequence of data for the selected services. Broadcast server 404 converts the data to the appropriate format for transmission (i.e. an FM signal) and relays it to broadcast tower 402. In an alternative example, scheduler 406 communicates the selected services to the broadcast server. The broadcast server schedules the time interval for transmission of the selected service.

Each broadcast transmission corresponds to the transmission of one or more frames that are arranged in accordance with a frame protocol. Each frame may include multiple messages, where some messages are public broadcast (aka “global” or “shared” messages), while other messages are client specific messages (aka “personal” or “private” messages). Each frame includes a table of contents that indicates the extent of messages that are found within the next transmitted frame. Every client that is located within the designated service region receives the shared and personal messages. Personal messages, however, may only be decoded by a single client.

Each frame includes a header, a table of contents, and a message payload that includes the content for one or more selected services as previously described. The header also includes other information such as authentication data, identified service region, language, available stations for the identified service region, frame number, and time stamp. Control information may also be included in one of the headers to indicate broadcast conditions such as a change in available channels, an assignment of a service region to a particular wireless client device, and an assignment of a particular channel (frequency). In one example, each frame includes a change counter in one of the headers to indicate a change has taken place in the system. Wireless client devices (clients) may use the change counter to determine when to initiate a failover (when a broadcast tower becomes unavailable).

Client devices can determine the current service region based on information that is included in the broadcast transmissions. The time zone can be determined based on the current service region such that the client device can adjust any time related information. Moreover, the time and date functions of the client device may be synchronized based on information that is included in the broadcast transmissions.

The electronic device stores the location of where to look for the user's calendar content within the broadcast.

City names, Sports team names, and location venues change fairly rarely and therefore may be sent by broadcast server 404 as part of the configuration of the calendar channel on the electronic device. The electronic device stores the name and corresponding ID of the name such that when it receives a calendar broadcast transmission the device may match the ID with the name of the city/team name/venue. According to one embodiment, a stream of names is broadcast at predetermined intervals. When a device needs a name, the name is accessed within the stream by an index value. According to another embodiment, whenever a name changes a configuration message is prepared and sent to users who have selected that item. According to one embodiment, event information is broadcast in one stream with calendar information broadcast on a separate stream.

Updates to Device and Retention Rules

Broadcasts throughout the day are used to update the calendar content. The appointment information is broadcast more frequently than the events information. According to one embodiment, the appointment information is broadcast shortly after a change is made to the user's calendar. According to one embodiment, eight days of appointments are stored. More or less, appointments, however, may be stored.

According to one embodiment, each night at 12:00 AM the appointments for the previous are deleted from the website and the client and the next day of appointments is added to the data store.

Process Flow

Process flow diagrams for navigation function of an example electronic device are illustrated in FIGS. 5A-5D. The process flow diagram illustrated in FIG. 5A is predominately focused on channel splash activity. The process flow diagram illustrated in FIG. 5B is predominately focused on view activity. The process flow diagram illustrated in FIG. 5C is predominately focused on extended view activity. The process flow diagram illustrated in FIG. 5D is predominately focused on mode splash activity.

Every electronic device has at least one channel that corresponds to the home channel. For a watch type of device, the home channel corresponds to a time channel. However, different home channels can be assigned to every electronic device. Whenever the currently selected channel corresponds to the home channel, the previous channel corresponds to the last channel (if more than one channel exists on the device). Similarly, the next channel corresponds to the home channel when the current channel is the last channel in the channel list for the electronic device.

Every electronic device has a set of selectors (or buttons) that are selectively activated to navigate various functions in the device. Example selectors are illustrated in FIG. 3. For the purposes of the discussion below, each selector is indicated by a letter such as “A”, “B”, “C”, “D”, and “E”. Some alternate selector functions may be chosen by sustained activation of a selector button for a predetermined time interval (e.g., two seconds). The alternate selector functions are generally indicated in the figures by a “+”symbol that is adjacent to the selector functions' designating letter (e.g., “C+”).

The example electronic device described below includes at least four selectors as indicated by letters “A”, “B”, “C”, and “D”. The “E” selector may be arranged to provide additional functions such as backlighting, a back channel selector, as well as any other desired function. Additional extended functions may also be programmed and accessible through multiple selector combinations. For example, one function could be selected by holding the “D” and “A” selectors together (“D+”& “A+”) for a predetermined time interval. Additional extended functions can also be programmed using other selector combinations such as “D+”& “B+”, “A+”& “B+”, as well as others.

Channel Splash Operating State

The channel splash operating state is described as follows below with reference to FIG. 5A.

The electronic device has a default initial channel that is referred to as a home channel. The display is updated to indicate the currently selected channel at block 514. Processing continues to block 511 where the channel splash operating state is maintained in an idle state. The electronic system in the electronic device monitors the user interface (e.g., the four selectors) while in the channel splash IDLE state. Processing leaves the channel splash IDLE state when the user activates one or more of the selectors or a timeout has occurred. The display actively maintains the splash screen to indicate the current channel selection while the channel splash IDLE state is active at block 511. Splash screens may include one or more graphic elements and/or text elements. An example channel splash screen for a calendar channel is illustrated in FIG. 7. Splash screens may be accompanied by the activation of sound that provides an audible indicator that the channel has changed. The sound associated with the audible indicators may be the same for each channel splash screen, or unique based on either the particular channel or the particular channel type (e.g., news channels are one type, while messages are another type).

Processing flows from channel splash IDLE state 511 to the “navigate up” or “navigate to previous channel” function 512 when the “A” selector is activated. Processing continues from block 512 to block 514, where the display is updated based on the newly selected channel. After the display is updated, processing returns to channel splash IDLE state 511.

Processing flows from channel splash IDLE state 511 to the “navigate down” or “navigate to next channel” function 513 when either the “B” selector or the “C” selector is activated. Processing continues from block 513 to block 514, where the display is updated based on the newly selected channel. After the display is updated, processing again returns to channel splash IDLE state 511.

Processing flows from channel splash IDLE state 511 to the “navigate to first channel” or “navigate to home channel” function 515 when the “C+”selector is activated. The home channel navigation function can be accessed from any channel of the electronic device. The electronic device navigates to the home channel (e.g., the time channel on a watch device) when the “navigate to home channel” function is activated. Processing continues from block 513 to block 514, where the display is updated based on the newly selected channel (i.e., the home channel). After the display is updated, processing again returns to channel splash IDLE state 511.

Processing flows from the channel splash IDLE state 511 to the “enter channel” function 516 when the “D” selector is activated. Alternatively, the “enter channel” function is activated when the electronic system is maintained in the channel splash IDLE state for a predetermined time interval (e.g., a 2 second timeout) without activation of a selector. Processing flows from block 516 to block 524 (see FIG. 5B) when the “enter channel” function is activated as indicated by “V”.

The enter channel function performs a series of initializations in the electronic device prior to leaving the channel splash operating state and entering the channel view operating state. Every channel in the electronic device has at least one operating mode. The electronic device selects the current operating mode as a default mode, and a current view as a default view in the currently selected channel when the “enter channel” function is activated.

In one example, a calendar channel has an appointment mode, an events mode, and a month view mode. Multiple views may be associated with each operating mode.

Channel View Operating State

The channel view operating state is described as follows below with reference to FIG. 5B.

The electronic device enters the channel view operating state at entry point V, where the selector functions associated with the currently selected channel and operating mode are mapped to the selectors. The display is updated to indicate the currently selected view at block 524. Processing continues to block 521 where the channel view operating state is maintained in an IDLE state. The electronic system in the electronic device monitors the user interface (e.g., the four selectors) while in the view IDLE state. When the user activates one or more of the four selectors, processing leaves the view IDLE state.

The display actively maintains the current view while the view IDLE state is active at block 521. List type views include lists of items that can be selected. Other types of views are simply graphical and/or textual elements that are arranged in a display view. Views may be accompanied by the activation of sound that provides an audible indicator that the view has changed. The sound associated with the audible indicators may be the same for each view (e.g., a beep type of indicator or sound clip), or unique based on the particular view. In one example, an audible indicator is activated when a particular alert notification function is activated.

Processing flows from the view IDLE state 521 to the “previous view” or “previous item” function 522 when the “A” button selector is activated. Processing continues from block 522 to block 524, where the display is updated based on the newly selected view. After the display is updated, processing returns to view IDLE state 521. In one example, the previous view corresponds to the last view when the currently selected view is the first available view in the current mode for the current channel. In another example, the previous view corresponds to an empty view (e.g., “no weather”, “no data”, etc.) when the currently selected view is the first available view in the current mode for the current channel. In still another example, the previous item in a list is highlighted when the “A” selector is activated.

Processing flows from view IDLE state 521 to the “next view” or “next item” function 513 when the “B” selector is activated. Processing continues from block 523 to block 524, where the display is updated based on the newly selected view. After the display is updated, processing again returns to view IDLE state 521. In one example, the next view corresponds to the first view when the currently selected view is the last available view in the current mode for the current channel. In another example, the next view corresponds to an empty view when the currently selected view is the last available view in the current mode for the current channel. In still another example, the next item in a list is highlighted when the “B” selector is activated.

Processing flows from view IDLE state 521 to the “mode splash” function when the “C” selector (e.g., “mode select”) is activated as indicated by “M”. Refer to FIG. 5D and related discussion for details.

Processing flows from view IDLE state 521 to the select home channel splash function when the “C+” selector is activated as indicated by “H”. Refer to FIG. 5A and related discussion for details.

The “D” selector is defined within the context of the current channel, mode, and view. The “D” selector may be defined as a “delete” function, and “enter extended view” function, a “select” function, or an “execute action” function. Not every view in a given channel/mode has an extended view as may be indicated by a null value. Some views may have an action function that is defined within the context of the view in the currently selected mode/channel. The context for each view is assigned to the mode upon entry into the mode for the current channel.

Processing flows from the view IDLE state 521 to the “enter extended view” function when the “D” selector is activated and the extended view is available as indicated by “D(EV)”. The extended view is available when defined within the context of the currently selected view. For example, the extended view may be available for a list type view such that the highlighted list item is selected when the “D” selector is activated, and a detailed view associated with the highlighted item is displayed as an extended view. Refer to FIG. SC and related discussion for details on the extended view processing.

Processing flows from view IDLE state 521 to the “execute action” function at block 526 when the “D” selector is activated and the action function is available as indicated by “D(ACT)”. The action function is defined within the context of the currently selected view. For example, a fortune cookie mode may be available in an entertainment channel. Although the fortune cookie mode may only have a single view, the “D” selector may be mapped to an action function that randomly selects fortunes from a list when the “D” selector is activated. After the action is performed (e.g., retrieve random fortune from list, execute an animation sequence), processing continues to block 524 where the display is updated as previously described.

Other special functions may be mapped to the “A+”, “B+”, and “D+”selectors within the context of the current view. By activating the corresponding selector for a predetermined time interval (e.g., 2 seconds) the corresponding special function is activated as indicated by block 525. Processing continues from block 525 to block 524 where the display is updated as previously described.

In one example, a list browser function is available in a mode that corresponds to cities. For this example, activation of the “A” and “B” selectors result in manual navigation through views that correspond to previous or subsequent stories. Activation of the “A+”or “B+”selector may activate a speed browse function.

In another example, a delete fuiction may be available in a view that corresponds to a specific appointment or event associated with the calendar channel. Activation of the “D+”selector may activate a delete function that removes the currently selected story from the electronic device.

In still another example, processing may flow from view IDLE state 521 to an “alternate view” function when the electronic system is maintained in the channel splash IDLE state for a predetermined time interval (e.g., a 2 second timeout) without activation of a selector. For example, no action for a predetermined amount of time may result in views associated with the channel automatically rotating to other views associated with the channel.

Extended View Operating State

The extended view operating state is described as follows below with reference to FIG. 5C.

The electronic device enters the extended view operating state at entry point EV, where the selector functions associated with the currently selected extended view are mapped to the selectors. The display is updated to indicate the currently selected extended view at block 534. Processing continues to block 531 where the extended view operating state is maintained in an IDLE state. The electronic system in the electronic device monitors the user interface (e.g., the four selectors) while in the extended view IDLE state. When the user activates one or more of the four selectors, processing leaves the extended view IDLE state.

The display actively maintains the current extended view while the extended view IDLE state is active at block 531. Extended views include graphical and/or textual elements that are arranged in a display view. Extended views may be accompanied by the activation of sound that provides an audible indicator that the extended view has changed. The sound associated with the audible indicators may be the same for each extended view (e.g., a beep type of indicator or sound clip), or unique based on the particular extended view.

Processing flows from extended view IDLE state 531 to the “previous view” or “previous item” function 532 when the “A” selector is activated. Processing continues from block 532 to block 534, where the display is updated based on the newly selected extended view. After the display is updated, processing returns to extended view IDLE state 531. In one example, the previous view corresponds to the last extended view when the currently selected extended view is the first available extended view for the current channel/mode. In another example, the previous extended view corresponds to an empty view (e.g., “no appointments”, “no events”, “no data”, etc.) when the currently selected extended view is the first available extended view in the current channel/mode.

Processing flows from extended view IDLE state 531 to the “next view” or “next item” function 533 when the “B” selector is activated. Processing continues from block 533 to block 534, where the display is updated based on the newly selected extended view. After the display is updated, processing returns to the extended view IDLE state 531. In one example, the next view corresponds to the first extended view when the currently selected extended view is the last available extended view for the current channel/mode. In another example, the next extended view corresponds to an empty view (e.g., “no events”, “no data”, etc.) when the currently selected extended view is the last available extended view in the current channel/mode.

Processing flows from extended view IDLE state 531 to the “mode splash” function when the “C” selector (e.g., “mode select”) is activated as indicated by “M”. Refer to FIG. 5D and related discussion for details.

Processing flows from extended view IDLE state 531 to the view function when the “D” selector is activated as indicated by “V”. In another example, processing flows from extended view IDLE state 531 to the view function when a timeout interval expires (e.g., 5 seconds). Refer to FIG. 5B and related discussion for details concerning the view functions.

Processing flows from extended view IDLE state 531 to the select home channel splash function when the “C+”selector is activated as indicated by “H”. Refer to FIG. 5A and related discussion for details.

Special functions may be mapped to the “A′”, “B”, “A+”, and “B+”selectors within the context of the current view. By activating the corresponding selector for a predetermined time interval (e.g., a 2 second timeout interval) the corresponding special function is activated as indicated by block 535. Processing continues from block 535 to block 534 where the display is updated as previously described.

Mode Splash Operating State

The model splash operating state is described as follows below with reference to FIG. 5D.

The electronic device enters the mode splash operating state at entry point M. The display is updated to indicate the currently selected mode at block 545. Processing continues to block 541 where the mode splash operating state is maintained in an IDLE state. The electronic system in the electronic device monitors the user interface (e.g., the four selectors) while in the mode splash IDLE state. When the user activates one or more of the four selectors, processing leaves the mode splash IDLE state.

The display actively maintains the current mode splash display while the mode splash view IDLE state is active at block 541. Mode splash views include graphical and/or textual elements that are arranged in a display view.

Example mode splash displays for a calendar channel are illustrated in FIG. 7. Mode splash displays may be accompanied by the activation of sound that provides an audible indicator that the selected mode has changed. The sound associated with the audible indicators may be the same for each mode splash (e.g., a beep type of indicator or sound clip), or unique based on the particular mode selected.

Processing flows from mode splash IDLE state 541 to the “previous mode” function 542 when the “A” selector is activated. Processing continues from block 542 to block 544, where the display is updated based on the newly selected mode. After the display is updated, processing returns to mode splash IDLE state 541. In one example, the previous mode corresponds to the last mode when the currently selected mode is the first available mode for the current channel.

Processing flows from mode splash IDLE state 541 to the “next mode” function 543 when the “B” selector is activated. Processing continues from block 543 to block 544, where the display is updated based on the newly selected mode. After the display is updated, processing returns to mode splash IDLE state 541. In one example, the next mode corresponds to the first mode when the currently selected mode is the last available mode for the current channel.

Processing flows from mode splash IDLE state 541 to the “channel splash” function when the “C” selector (e.g., “channel select”) is activated as indicated by “CS.” Refer to FIG. 5A and related discussion for details.

Processing flows from mode splash IDLE state 541 to the “select default view” function 545 when the “D” selector is activated. Alternatively, processing may flow from mode splash IDLE state 541 to the “select default view” function 545 when a timeout interval (e.g., a 2 second interval) has expired. Processing continues from block 545 to the channel view operating state as indicated by “V”. Refer to FIG. 5B and related discussion for details.

Processing flows from mode splash IDLE state 541 to the select home channel splash function when the “C+”selector is activated as indicated by “H”. Refer to FIG. 5A and related discussion for details.

Example Display Screen Partitions FIG. 6 is a diagram (600) illustrating views for display screens (610, 610′) on an example electronic device such as a watch that is arranged in accordance with the present invention. Example display screen (610) is partitioned into two regions: a header region (620) and a main body region (630).

The main body region of the display screen may include one or more graphical and/or textual information fields that change based on the current context in the current channel, mode, and operating state. In one example context, the main body region is a single text region for displaying a text message (610″). In another example context, the main body section (610″) may include a graphical representation of the current month in a calendar.

The header region of the display screen may include one or more graphical and/or textual information fields that change based on the current context in the current channel, mode, and operating state. In one example context, the header section (620) may include two regions: a current time field (621) and a current date field (622). In another example context, the header section (620′) may include three regions: a current time field (621′), a current date field (622′), and a status indicator field (623). In yet another example context (e.g., a message view), the header section (620″) includes an identifier for a message (e.g., the originator of the message might be “JohnC”). In still another example context (e.g., a calendar month view), the header section (620″) may include a single field for a date such as “Feb 2002”.

Status indicators may be associated with various conditions such as alerts in the electronic device. One example header (650) includes a status indicator for an internal alert such as an exclamation point symbol. Another example header (651) includes a status indicator that an alarm is set such as an alarm clock symbol. Yet example header (652) includes a status indicator of signal strength in a wireless connection such as signal strength bars. Still another example header (653) includes a status indicator that a timer is running such as an hourglass symbol. Yet still another example header (654) includes a status indicator that the battery is low such as an empty battery symbol. Still another example header (655) includes a status indicator that the battery is charging such as a lightning bolt symbol. Still yet another example header (656) includes a status indicator that a timer is running such as a chronograph symbol.

The above specification, examples and data provide a complete description of the manufacture and use of the composition of the invention. Since many embodiments of the invention can be made without departing from the spirit and scope of the invention, the invention resides in the claims hereinafter appended.

1. A method for receiving, displaying and interacting with calendar channel content on a mobile electronic device, comprising:
receiving the calendar channel content that is encoded on a communication signal, wherein the communication signal is broadcast to many electronic devices and includes calendar channel content for a specific user;
storing at least a portion of the calendar channel content on the electronic device;
associating the calendar channel content with a calendar channel application on the electronic device;
setting a current view associated with the calendar channel; and
displaying the current view on a display of the electronic device.

2. The method of claim 1, wherein setting the current view further comprises setting the current view to at least one of: an appointment view; an events view; and a month view.

3. The method of claim 1, wherein setting the current view associated with the calendar channel, further comprises selecting a mode, wherein the mode is selected from at least one of: an appointments mode; an events mode; and a month view mode.

4. The method of claim 3, further comprising receiving an input indicating a selection associated with one of the modes; and in response to the selection setting the current view.

5. The method of claim 2, further comprising determining when a detail view is selected; and in response to the detail view being selected showing details associated with the selected detail view.

6. The method of claim 3, wherein the appointments mode includes a list of events and appointments for the user.

7. The method of claim 6, wherein setting the current view, further comprises automatically setting the current view to an upcoming appointment view that shows the user of upcoming appointments.

8. The method of claim 1, further comprising automatically receiving updates to the calendar channel content throughout a day.

9. The method of claim 8, further comprising automatically retrieving calendar information from the user's primary calendar program and encoding at least a portion of the calendar information onto the communication signal.

10. The method of claim 1, further adjusting the current view based on user preferences.

11. An apparatus for receiving, navigating, and displaying calendar content, comprising:
a data store;
a communication connection configured to receive a communication signal including the calendar content and store at least a portion of the calendar content in the data store; wherein the communication signal is directed to a plurality of mobile electronic devices;
a display;
a user interface that includes a selector; and
an electronic system that is arranged to interact with the user interface, the data store, the communication connection, and the display, wherein the electronic system is configured to:
select a current view from at least one of the set of views including: an appointment view; an events view; and a month view; and
display the current view on the display.

12. The apparatus of claim 11, wherein the electronic system is further configured to select a details view associated with the current view in response to the selector.

13. The apparatus of claim 12, wherein the appointments view includes calendar information that is retrieved from a user's calendar program on another device.

14. The apparatus of claim 13, wherein the electronic system is further configured to automatically receive the communication signal including the calendar content that includes updates to the calendar content.

15. The apparatus of claim 14, further comprising adjusting the calendar content received by the device based on user preferences.

16. A system for providing and interacting with calendar content, comprising:
a data collector configured to collect the calendar content associated with a calendar channel;
a broadcast device configured to transmit a communication signal to a plurality of mobile electronic devices at the same time, wherein the communication signal includes the calendar content encoded thereon;
a mobile electronic device, having:
a data store;
a communication connection configured to receive the communication signal and store the calendar content in the data store;
a display;
a user interface that includes a selector; and
an electronic system that is arranged to interact with the communication connection, the user interface, the data store and the display, wherein the electronic system is configured to:
select a current view associated with the calendar channel;
change the current view in response to the selector; and
display the current view on the display.

17. The system of claim 16, wherein the calendar content includes at least one of the following: appointment information and event information.

18. The system of claim 17, wherein the broadcast device is configured to broadcast an FM communication signal.

19. The system of claim 18, further comprising a user's calendar program configured to provide a user's calendar information to the broadcast device so that at least a portion of the calendar information may be encoded onto the communication signal.

20. The system of claim 17, further comprising a server configured to receive appointment information associated with a user receiving the calendar channel.
